(19) United States
(12) Patent Application Publication
(10) Pub. No.: US 2020/0300212 A1
(43) Pub. Date: Sep. 24, 2020

(54) Methods and Systems for Harvesting Waste Wind Energy

(71) Applicant: Fansonfans Inc., Clarence, NY (US)

(72) Inventor: Christian Anderson, Clarence, NY (US)

(21) Appl. No.: 16/360,200

(22) Filed: Mar. 21, 2019

(51) Int. Cl. F03D 1/04; F03D 1/06; H02K 7/18

(52) U.S. Cl. CPC F03D 1/04; F03D 1/0625; H02K 7/183; F05B 2210/12; F05B 2240/14; F05B 2220/60; F05B 2240/221; F05B 2240/301; F05B 2210/20

(57) ABSTRACT

Disclosed herein are systems and methods for generating electric power from an exhaust wind expelled by an exhaust system having an exhaust outlet. Such systems may comprise, and methods may utilize, a conical framework, a Newtonian turbine, and an electric generator. The conical framework and the Newtonian turbine may be disposed substantially downstream of the exhaust outlet. The Newtonian turbine may be positioned at a first distance from the exhaust outlet, may be substantially concentric with the conical framework, and may be disposed partially or completely within the conical framework. The conical framework may enhance the capture of wind energy by the Newtonian turbine. Thus, a portion of the unused energy from unnatural wind sources can be captured, such as those described herein, and returned to the power grid to enable higher efficiency of machinery operation.

### FIELD OF THE DISCLOSURE

The disclosure generally relates to waste energy harvesting. More particularly the disclosure generally relates to waste energy harvesting using a wind turbine.

### BACKGROUND OF THE DISCLOSURE

Conventional wind turbine systems utilize the kinetic energy from the wind, which is in turn used to rotate the blades of the turbine by making use of Bernoulli's principle (an increase in in the speed of the fluid occurs simultaneously with a decrease in pressure).

Unnatural wind sources may include systems that have high volumes of exhaust produced by various machines, including ventilation, heat exchange, air conditioning, or other exhaust systems. Such systems draw electricity from the power grid to spin a fan or start a blower. This process produces exhaust air in various manufacturing plants, power plants, homes, and businesses. This energy is effectively returned to the atmosphere and is not utilized by hardware or machinery sold on the market today.

Many manufacturing plants around the world line their walls with high volume ventilation systems—many of which run full-time. For example, in cold climates, fans often run twenty-four hours per day to prevent freezing. These produce significant energy through the generation of wind. This energy is never utilized.

Manufacturing plants also vent all kinds of air for removing chemicals, heat, dust, etc. Along with high volume ventilation fans, cooling towers produce wind while cooling power plants and other structures.

Air conditioning units use fans to cool their condensers. These are located on many homes, businesses, and various other buildings.

Therefore, waste wind energy sources exist, and such waste wind energy sources can be harvested as a source of energy.

### SUMMARY OF THE DISCLOSURE

An embodiment of the present disclosure includes a system for generating electric power from an exhaust wind expelled by an exhaust system having an exhaust outlet. The system may comprise a conical framework, a Newtonian turbine, and an electric generator. The conical framework may be disposed substantially downstream of the exhaust outlet. The Newtonian turbine may be disposed substantially downstream of the exhaust outlet. The Newtonian turbine may be positioned at a first distance from the exhaust outlet, and may be substantially concentric with the conical framework. The Newtonian turbine may be disposed partially or completely within the conical framework.

Another embodiment of the present disclosure is a method for generating electric power from an exhaust wind expelled by an exhaust system having an exhaust outlet. Such a method may comprise passing the exhaust wind through a conical framework; impinging the exhaust wind on a Newtonian turbine operatively connected to a low-speed driveshaft after passing the exhaust wind through a portion of the conical framework; and generating electric power using an electric generator.

There may be support legs connected to the conical framework. The conical framework may be connected to the exhaust outlet. The conical framework may be connected to the exhaust system using a ring brace. The Newtonian turbine, the low-speed driveshaft, and the electric generator may be disposed within the conical framework. The conical framework may include a duct disposed such that a portion of the exhaust wind passes through the duct before impinging on the Newtonian turbine. The duct may be converging, diverging, or straight. A conical framework inlet diameter of a conical framework inlet of the conical framework may be smaller than an exhaust outlet diameter of the exhaust outlet. The conical framework may be tapered such that it is substantially frustoconical in shape, so that the conical framework may have an inlet diameter of an inlet smaller than an outlet diameter of an outlet.

There may be a regulation system configured to regulate a taper of the conical framework. The regulation system may be a hydraulic system. The regulation system may be controlled by a controller based on a wind speed input and a maximum operating torque of the electric generator. The wind speed input may include a wind speed measured by an anemometer.

The first distance may be determined to maximize a wind velocity through the turbine, to minimize an accumulation of heat or air between the exhaust outlet and the Newtonian turbine, or based on an exhaust outlet diameter of the exhaust outlet.

The Newtonian turbine may include a rotor, a hub, and a turbine blade. The Newtonian turbine may be connected to the conical framework via a bearing.

The rotor may have an outer rotor surface and a rotor diameter. The rotor may be operatively connected to a low-speed driveshaft.

The hub may be substantially concentric with the rotor. The hub may have an inner hub surface and a hub diameter. The hub diameter may be smaller than or substantially equal to an exhaust outlet diameter of the exhaust outlet. The hub may be tapered such that it is substantially frustoconical in shape, so that the hub may have an inlet diameter of an inlet smaller than an outlet diameter of an outlet.

The turbine blade may have a first blade end and a second blade end. The first blade end may be connected to the outer rotor surface and the second blade end may be connected to the inner hub surface. There may be multiple rotor blades, each having a respective first blade end and second blade end, with each respective first blade end connected to the outer rotor surface and each respective second blade end connected to the inner hub surface.

The electric generator may include a high-speed driveshaft. The high-speed driveshaft may be operatively connected to the low-speed driveshaft. The electric generator may be configured to generate electric power when the high-speed driveshaft is turned. The electric generator may be an asynchronous generator, a doubly-fed induction generator, a permanent magnet system generator, or a squirrel cage induction generator.

The low-speed driveshaft may be supported by a bearing and a mount, and the high-speed driveshaft may be operatively connected to the low-speed driveshaft via a gearbox.

In some embodiments, there may be an extrusion on the fan blade. Such an extrusion may have a cross-section of a right triangle having a straight or curved hypotenuse.

### BRIEF DESCRIPTION OF THE FIGURES

For a fuller understanding of the nature and objects of the disclosure, reference should be made to the following detailed description taken in conjunction with the accompanying drawings, in which:

FIG. 1 illustrates a wind turbine system;

FIG. 2 illustrates a Newtonian turbine;

FIG. 3 illustrates a wind turbine system;

FIG. 4 illustrates a wind turbine system;

FIG. 5 illustrates a wind turbine system;

FIG. 6 illustrates a conical framework;

FIG. 7 illustrates a hydraulics system installed on a conical framework;

FIG. 8 illustrates variations of a conical framework;

FIG. 9 illustrates a wind turbine system utilizing a doubly-fed induction generator;

FIG. 10 illustrates a wind turbine system utilizing a permanent magnet system controller;

FIG. 11 illustrates a wind turbine system utilizing a squirrel cage induction generator;

FIG. 12 illustrates a triangular rivet;

FIG. 13 illustrates a test configuration;

FIG. 14 illustrates a test configuration result;

FIG. 15 illustrates a test configuration result; and

FIG. 16 illustrates a method according to the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

All ranges provided herein include all values that fall within the ranges to the tenth decimal place, unless indicated otherwise.

Embodiments disclosed herein include energy harvesting systems and methods of using the same. A harvesting system may comprise a Newtonian turbine operating in concert with a conical framework to harness energy produced by unnatural wind sources such as, inter alia, cooling towers, high-volume ventilation fans, and air conditioning unit condenser fans. Other wind sources are possible and these are merely listed as examples. In this way, the harvesting turbine may convert incoming kinetic energy from exhaust or other waste wind into rotating mechanical energy.

The wind produced by unnatural wind sources may be harvested in energy recovery according to embodiments of the present disclosure. Thus, a portion of the unused energy from unnatural wind sources can be captured, such as those described herein, and returned to the power grid to enable higher efficiency of machinery operation.

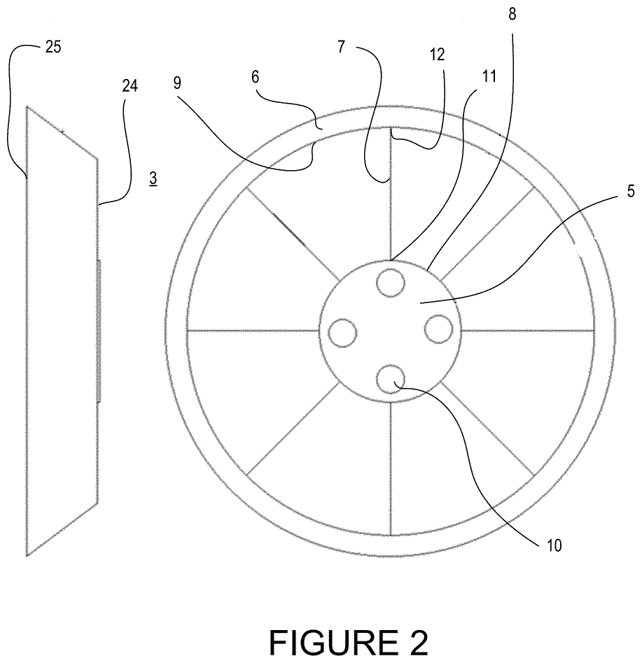

The present disclosure includes a Newtonian turbine. A Newtonian turbine uses Newton's second law of motion to exploit wind energy, as compared to typical wind turbines in the art that rely on Bernoulli's principle (e.g., a Bernoulli turbine). A Newtonian turbine is configured to operate based on the impact of an air mass on its blades. A Bernoulli turbine operates based on low-pressure zones to increase wind velocity. A Newtonian turbine in accordance with the present disclosure is predicted to produce nearly one hundred times more electricity converted from wind energy as compared to a Bernoulli turbine of comparable size. FIG. 2 illustrates an example Newtonian turbine. A Newtonian turbine may include curved and overlapping blades and a tapered edge to decrease resistance.

A conical framework according to the present disclosure can be placed downstream of exhaust systems and supported. The conical framework may also house the Newtonian turbine and may house bearings, mounts, braces, a gearbox, and a generator. The Newtonian turbine can be placed at the beginning of the conical framework and may be connected to a low-speed driveshaft. The low-speed driveshaft may be connected to a high-speed driveshaft via a gearbox. The high-speed driveshaft may be connected to the generator.

The entire structure, which may include the conical framework, may be mounted using support structures or braces, which are attached to the walls where the exhaust fan is located. System stands and welding may be used to connect the fans themselves and support the structure of the turbine.

As wind exits an exhaust system, vortices may be created around the edges of the exhaust outlet. These vortices may form circular shapes and eventually converge back together in a triangular shape, and may have a maximum wind velocity at a certain distance from the exhaust outlet.

The wind may be funneled and concealed in a conical duct system, or conical framework. The conical framework may be decreasing in size (converging), similar to a Venturi, or increasing in size (diverging). The conical framework may have a system of flow straighteners to control turbulence in the wind passing through it.

The conical framework may include a hydraulic system configured to control the expansion or contraction of the conical framework, thus regulating wind velocity. This could be used in a variable-wind-speed design. The hydraulic system can be controlled by a microcontroller, or processor. The microcontroller can be configured to receive readings from a small anemometer installed in the wind stream path to adjust, and it can adjust the pitch of the conical framework accordingly to attain maximum power generation efficiency. The maximum power generation efficiency may be ascertained from a power generation curve for induction motors.

Another embodiment of the present disclosure includes a triangular rib design for fan blades. The design would incorporate small triangles, which could be right triangles, or other curved structures along the front side of a fan blade. These triangles may have an arcuate hypotenuse. The small triangles can contribute to the formation of eddies on the blade's pressure side, thus increasing the wind velocity and increasing efficiency of the energy conversion.

One embodiment of the present disclosure is a fixed system. The fixed system uses an asynchronous generator in combination with a gearbox to generate power with similar voltage and frequency characteristics to the supply line. In the fixed system, the fans operate at a relatively constant speed (e.g., revolutions per minute). The fixed system may also include a three-phase soft starter for protection and stability.

Another embodiment of the present disclosure is a system using a permanent magnet system and a converter to produce varying levels of power at varying fan speeds.

Embodiments disclosed herein include a system for generating electric power from an exhaust wind expelled by an exhaust system having an exhaust outlet.

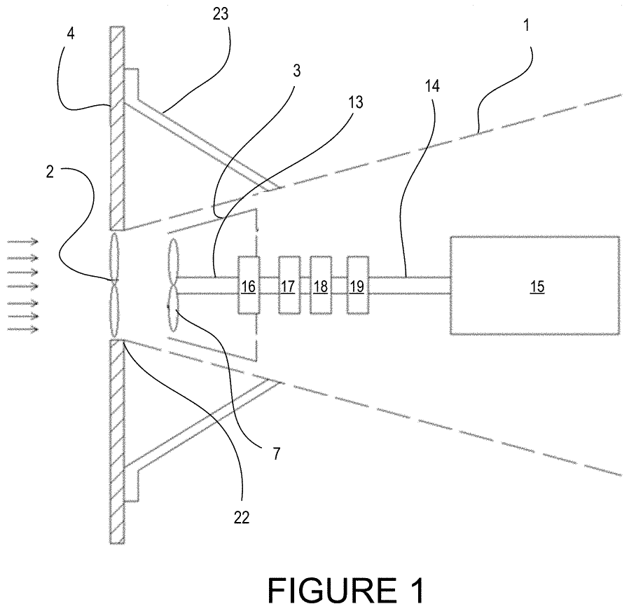

As depicted in FIG. 1, a conical framework 1 may be disposed substantially downstream of an exhaust outlet 2. A Newtonian turbine 3 having blade(s) 7 may be disposed substantially downstream of exhaust outlet 2, at a first distance from exhaust outlet 2. The first distance may be determined to maximize a wind velocity through Newtonian turbine 3, or at the blade(s) 7 of Newtonian turbine 3, and may be determined based on an exhaust outlet diameter of the exhaust outlet. Alternatively, the first distance may be determined to minimize an accumulation of heat or air between exhaust outlet 2 and Newtonian turbine 3. Conical framework 1 and Newtonian turbine 3 may have a substantially circular cross section, and may be frustoconical in shape. Newtonian turbine 3 may be substantially concentric with conical framework 1. Newtonian turbine 3 may be operatively connected to a low-speed driveshaft 13. Low-speed driveshaft 13 may be operatively connected to high-speed driveshaft 14 of an electric generator 15. Electric generator 15 may be configured to generate electric power when high-speed driveshaft 14 is turned. Low-speed driveshaft 13 may be supported by bearing 16 and/or mount 17 and/or brace 18. Low-speed driveshaft 13 and high-speed driveshaft 14 may be operatively connected using a gearbox 19. Gearbox 19 may be designed appropriately to provide an optimal torque to electric generator 15 to maximize power generation based on design requirements and typical exhaust parameters.

Exhaust system 4 may include at least one ventilation fan or combustion source. Fluid dynamics testing can be performed to determine the most effective first distance the turbine should be placed from the exhaust system outlet to maximize captured wind velocity. For example, in a test, for a 60-inch fan, it was found that an optimal configuration included placing the turbine 16.5505 inches from the fan blades.

Exhaust outlet 2 may be positioned relative to an outer portion 4 of an exhaust system. For example, outer portion 4 may be a wall.

Bearing 16 may be used to connect Newtonian turbine 3 to conical framework 1.

Conical framework 1 may be connected to exhaust outlet 2, exhaust system 4, via, for example, structural supports 23. Conical framework 1 may have legs connected to it to provide support.

Conical framework 1 may serve to house some or all of the components of the system. Certain mechanical components, including Newtonian turbine 3, low-speed driveshaft 13, high-speed driveshaft 14, bearing 16, mount 17, brace 18, gearbox 19, and/or electric generator 7 may be disposed within conical framework 1. Conical framework 1 may be connected to exhaust outlet 2 using, for example, connection means 22. Alternatively, conical framework 1 may be connected to exhaust system 4 using, for example, supports 23. Further, conical framework 1 may be connected to exhaust system 4 using supports 23 and connection means 22. Connection means 22 may be a ring brace, multiple ring braces, or other appropriate connection means.

FIG. 2 depicts an embodiment of Newtonian turbine 3. Newtonian turbine 3 may include a rotor 5, a hub 6, and a blade 7. There may be multiple blades 7. Rotor 5 may have an outer rotor surface 8 and a rotor diameter. Rotor 5 may include a connection means 10 to operatively connect it to a low-speed driveshaft, such as low-speed driveshaft 13. Hub 6 may be substantially circular and substantially concentric with rotor 5. Hub 6 may have an inner hub surface 9 and a hub diameter. Blade 7 may have a first blade end 11 and a second blade end 12. First blade end 11 may be connected to outer rotor surface 8 and second blade end 12 may be connected to inner hub surface 9.

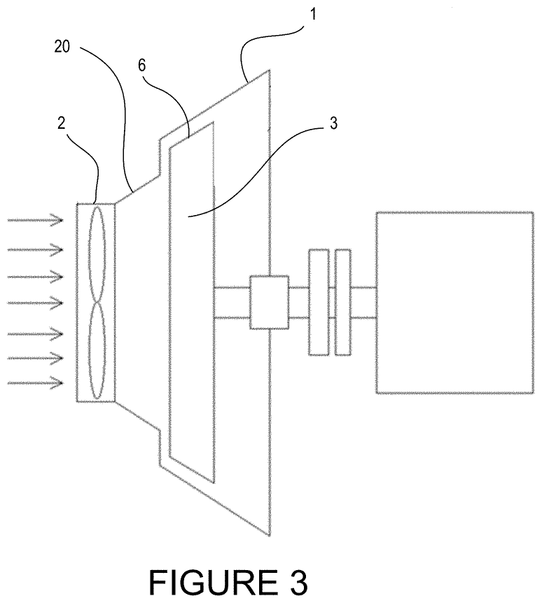

Hub 6 may have a hub diameter chosen such that the swept diameter of blade 7 is substantially equal to an exhaust outlet diameter of exhaust outlet 2, as depicted in FIG. 3. Alternatively, the hub diameter may be smaller than the exhaust outlet diameter, based on particular design requirements. In such a configuration, Newtonian turbine 3 may be located proximate the exhaust outlet.

Hub 6 may be tapered, and thus may have a frustoconical shape. In this way, hub 6 may have an inlet side 24 and an outlet side 25. In this way, the outlet side 25 may have a diameter that is greater than the diameter of an inlet side 24. Hub 6 may improve the efficiency of the capture of wind energy through the Newtonian turbine 3 by tuning its velocity. Hub 6 may have an approximately frustoconical shape and encompass blade 7 and rotor 5. The thickness of hub 6 may be selected based on the thickness of blade 7. With hub 6, the increase in volume and extra currents passing over a tapered edge of hub 6 results in generation of eddy currents in the downstream direction of the wind. This can result in formation of low-pressure zones, which improve the flow of the wind from the exhaust to the ambient space.

Tapered hub 6 may have the function of increasing the volume of wind passing through the Newtonian turbine 3 within the same diameter, but with reduced inlet area swept by the blade 7. The tapered hub 6 may also create eddies around the outer edges of hub 6. The increase of volume, along with the smaller swept area compared to the outlet area and the creation of eddies allows wind to pass through Newtonian turbine 3 with little-to-no resistance. This can reduce the stress to the fan(s) of exhaust system 4 Newtonian turbine 3 is placed downstream of to a near-negligible amount.

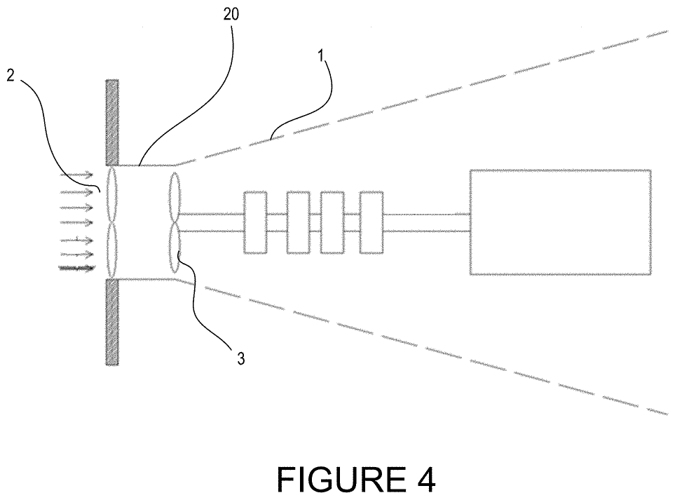

As depicted in FIG. 4, between exhaust outlet 2 and Newtonian turbine 3, a portion of conical framework 1 may be differently shaped. This differently shaped portion of conical framework 1 may be duct 20. Conical framework 1 and duct 20 may be configured such that a portion of the exhaust wind emitted from exhaust outlet 2 may pass through duct 20 prior to impinging on Newtonian turbine 3. Duct 20 may be converging, diverging, or straight. Duct 20 may also be designed so that portions of duct 20 vary between being converging, diverging, or straight. Duct 20 may conceal a portion or all of the wind energy produced by exhaust system 4.

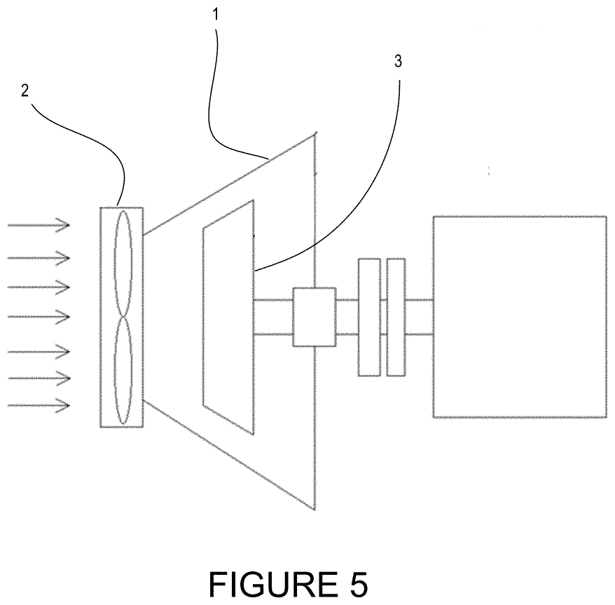

As depicted in FIG. 5, conical framework 1 may have a conical framework inlet diameter that is smaller than an exhaust outlet diameter of exhaust outlet 2. Thus, conical framework 1 may be an expanding conical shape used to create low-pressure zones to increase wind velocity. Newtonian turbine 3 may expand from smaller than the outlet of conical framework 1 to the full diameter. This allows air to pass over the tapered edge of Newtonian turbine 3, which creates an eddy, or turbulence, around the edge, developing a low-pressure zone. The low-pressure zone increases wind velocity by sucking air through the turbine and allowing air to pass through the turbine with little to no resistance. Conical framework 1 may expand to create a low-pressure zone, with Newtonian turbine 3 inside of it. Conical framework 1 may also have a small gap between it and hub 6 that allows some air to pass over the tapered edge of Newtonian turbine 3 in order to create eddies, or low-pressure zones, which can amplify the power of the wind produced. This allows air to pass through Newtonian turbine 3 with little to no resistance.

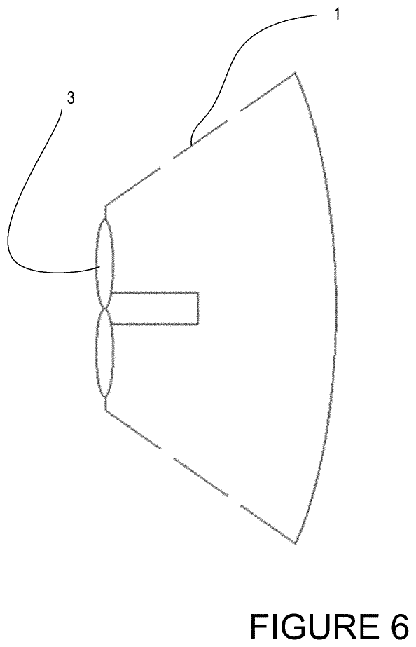

As depicted in FIG. 6, conical framework 1 may be tapered. In this way, an outlet diameter of conical framework 1 may be greater than the inlet diameter of conical framework 1. Thus, conical framework 1 may be an expanding conical shape, which may create low-pressure zones to increase wind velocity through Newtonian turbine 3. Newtonian turbine 3 may be located inside conical framework 1 to maximize the wind energy captured from exhaust system 4.

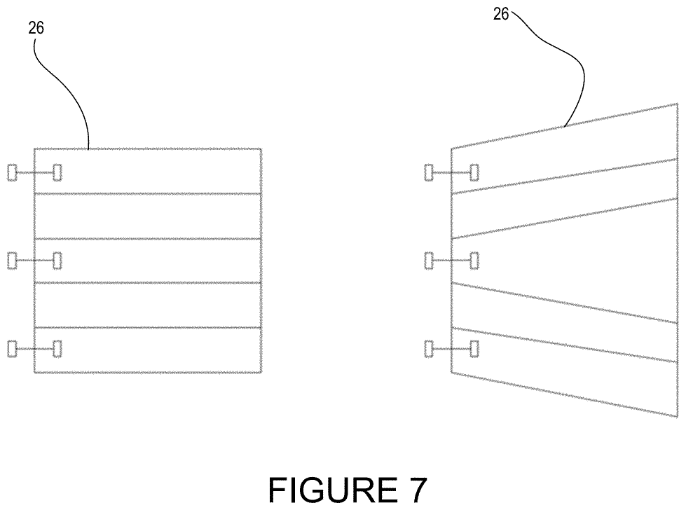

Conical framework 1 may be variably tapered using a regulation system 26 as depicted in FIG. 7. Changing the taper may change the wind velocities within conical framework 1, as can be used in variable wind speed system. Such a regulation system 26 may be a hydraulic system. Regulation system 26 may be controlled by a controller based on a wind speed input and a maximum operating torque of the electric generator. The wind speed input may include a wind speed measured by an anemometer.

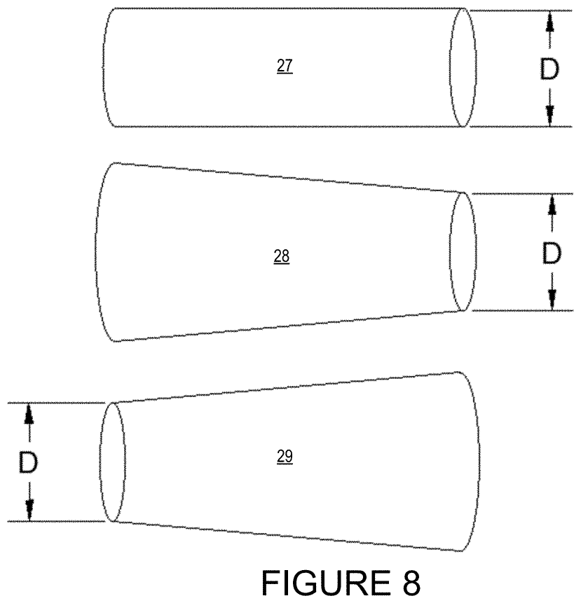

FIG. 8 depicts the various configurations of conical framework 1, including a straight conical framework 27, a converging conical framework 28, and an expanding conical framework 29. The various configurations of conical framework 1 may be a fixed form, or may be variably controlled and alternated between, such as by regulation system 26.

Conical framework 1 may have an inlet diameter smaller than the diameter of exhaust outlet 2, and an outlet diameter larger than the diameter of hub 6.

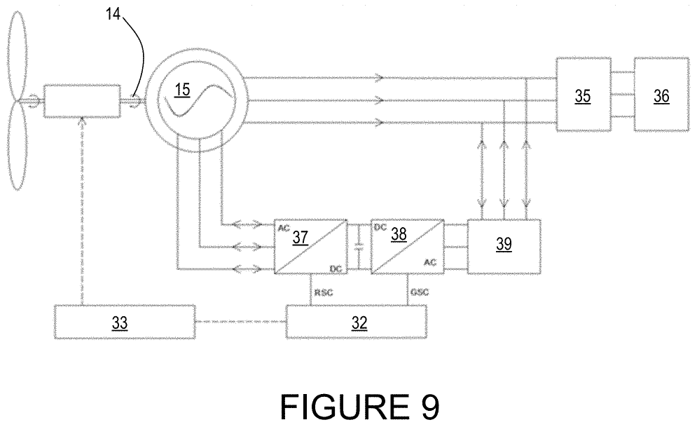

Various embodiments of electric generator 15 are depicted in FIGS. 9-11.

As depicted in FIG. 9, electric generator 15 may be a doubly-fed induction generator (DFIG), having a AC-DC converter 37, a DC-AC converter 38, a low pass filter 39, a converter controller 32, a wind turbine control 33, a 3-phase step-up transformer 35, and connected to a power grid 36. Where the velocity of wind from the exhaust fan varies up to +/±30% from the synchronous speed, a DFIG may be implemented as it has a feedback path to the generator rotor, which may be connected to the high-speed driveshaft, or may be the high-speed driveshaft. The power generation from the electric generator includes 70% power from the stator and 30% from the generator rotor. The stator may be directly connected to the grid and may provide an active power of constant voltage and frequency, even if there is a change in velocity of the wind. The output power coming from the generator rotor may have a variable frequency and voltage depending upon the change in wind speed. This may be modulated by using back to back AC-DC-AC converters connected through a DC link to produce an output power which is synchronized to the grid, connected using a low pass filter to eliminate noise.

The DFIG system may include a converter and a low-pass filter in the feedback generator rotor path. The DFIG system can permit up to 30% increase or decrease in the synchronous speed of the induction motor. This contributes to maximizing power generation and its return to the three-phase power supply.

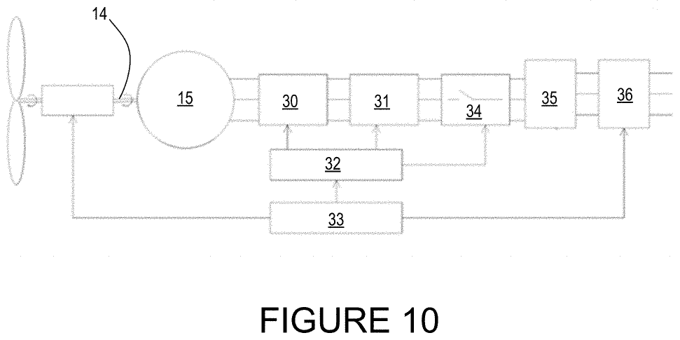

As depicted in FIG. 10, electric generator 15 may be a permanent magnet system generator (PMSG), having a generator side control 30, a grid side control 31, a converter controller 32, a wind turbine control 33, a main circuit breaker 34, a 3-phase step-up transformer 35, and connected to a power grid 36. PMSGs have a wide operational range for production of usable power. An embodiment employing a PMSG may include an electronic DC to AC converter before output to the grid. The PMSG unit itself may have a variable frequency AC output, which may be rectified to DC before reaching the converter. The converter may be designed to synchronize its output with the power grid to which it is connected. This may be implemented as a fixed or variable system.

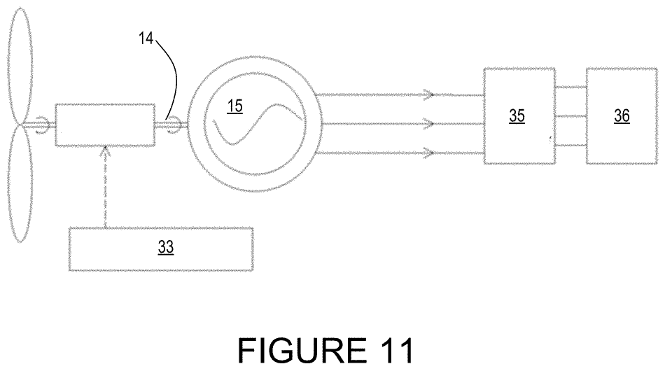

As depicted in FIG. 11, electric generator 16 may be an asynchronous generator, or squirrel cage induction generator (SCIG), having a wind turbine control 33, a 3-phase step-up transformer 35, and connected to a power grid 36. In this way, power may be fed directly back into the grid without passing through additional circuitry and thus transmission losses can be minimized.

Such embodiments are advantageous where wind velocity from the exhaust outlet is substantially constant. The SCIG configuration may include a turbine, gearbox, and asynchronous induction generator. The combination of the constant air flow coming out of exhaust outlet 2 and design of the gearbox 19 helps keep the SCIG operating at a relatively constant speed (e.g., revolutions per minute), which is roughly 3%-5% (slip) above the synchronous speed. This speed may result in the generation of maximum power and may be the same as the rated speed of the generator. The generator rotation speed may be monitored, and output of the generator may be connected only when the speed is within the optimal range for generating power.

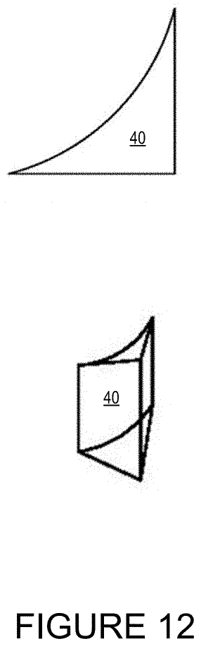

FIG. 12 depicts extrusion 40, which may be on blade 7. There may be one extrusion 40 on each blade 7, or there may be multiple extrusions 40 on each blade 7. Extrusion 40 may have a cross section of a right triangle. Extrusion 40 may also have a cross section of a right triangle, but with a curved hypotenuse. Extrusion 40 may produce eddies, or low-pressure zones, along the fan blades to maximize wind velocity and power generation.

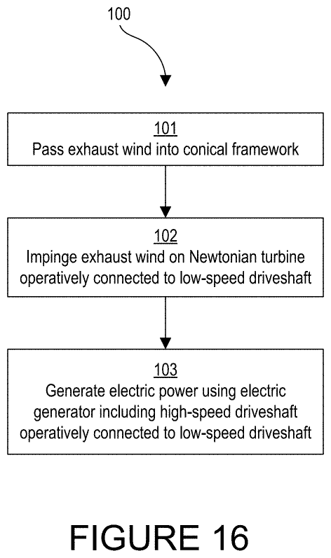

Embodiments disclosed herein also include a method for generating electric power from an exhaust wind expelled by an exhaust system having an exhaust outlet. As seen in FIG. 16, such a method 100 may comprise passing 101 the exhaust wind into a conical framework, impinging 102 the exhaust wind on a Newtonian turbine connected to a low-speed driveshaft after passing the exhaust wind through the conical framework, and generating 103 electric power using an electric generator, which may have a high-speed driveshaft.

The conical framework may be positioned at, or at a specified distance from, the exhaust outlet. The low-speed driveshaft may be operatively connected to the Newtonian turbine. The Newtonian turbine may be positioned a first distance from the exhaust outlet. The Newtonian turbine may include a rotor, a hub, and a turbine blade.

The rotor may have an outer rotor surface and a rotor diameter. The rotor may be operatively connected to a low-speed driveshaft.

The hub may be substantially concentric with the rotor, and may have an inner hub surface and a hub diameter. The turbine blade may have a first blade end and a second blade end. The first blade end may be connected to the outer rotor surface and the second blade end may be connected to the inner hub surface. The high-speed driveshaft may be operatively connected to the low-speed driveshaft, and the electric generator may be configured to generate electric power when the high-speed driveshaft is turned.

Embodiments of the present disclosure can benefit the environment significantly along with providing significant savings to operators. The present disclosure is unique, since it is able to harness the potential energy from the exhaust ventilation systems using a Newtonian turbine.

A typical Bernoulli turbine is expected to convert 0.5%-1.0% of the energy wind passing through its swept are into electricity. This is because much of the wind passing through a Bernoulli turbine's swept area is uncaptured, and thus captures only 4% of the potential wind energy passing through the diameter of the blades. In comparison, embodiments of the present disclosure capture nearly 100% of the wind energy passing through them as nearly all of the wind entering the swept area impinges on blade surfaces. Thus, embodiments of the present disclosure are expected to convert 40%-50% of the energy from wind passing through the swept area into electricity.

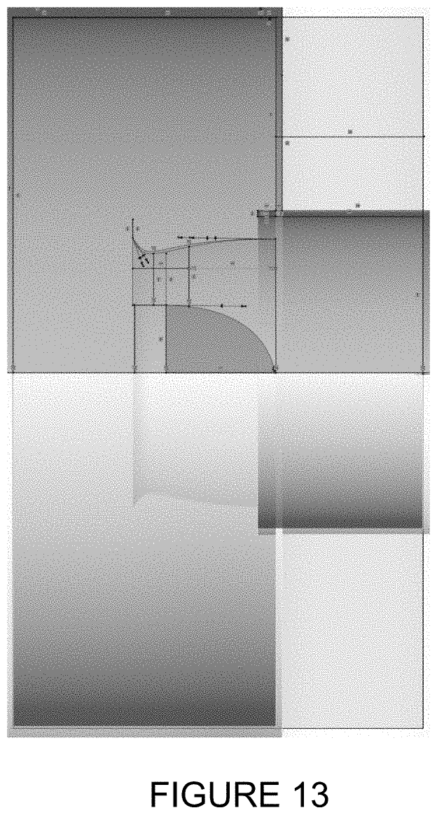

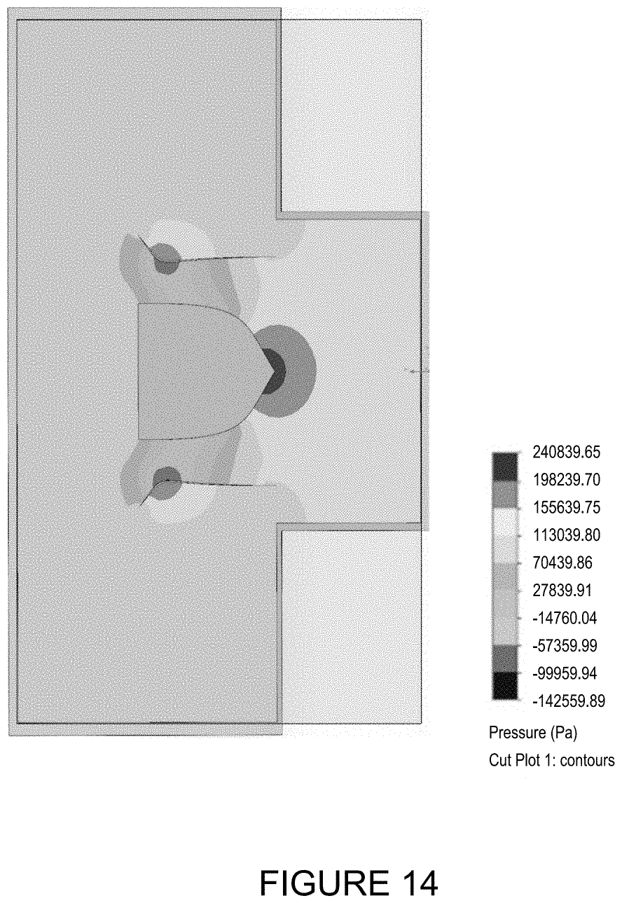

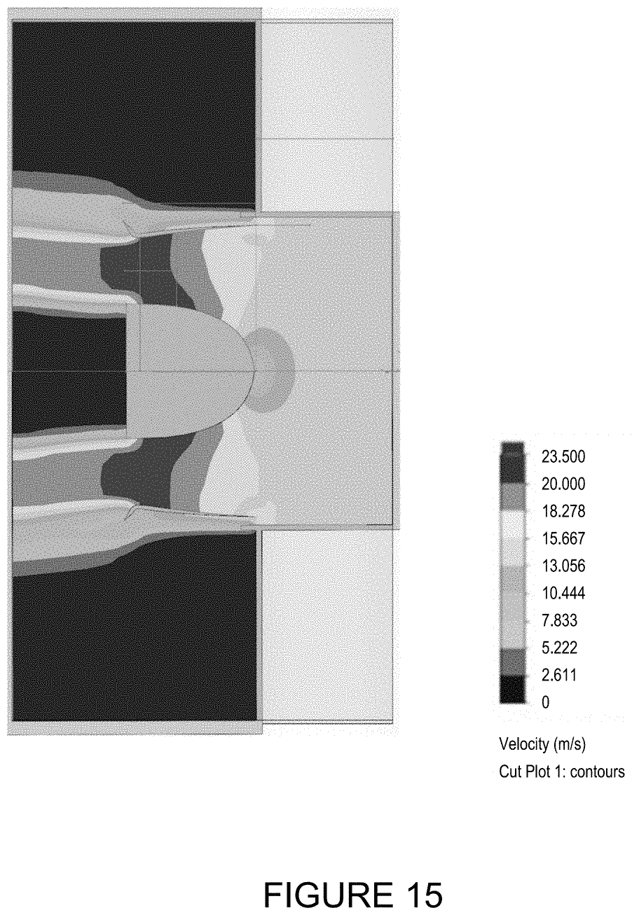

A test setup included a conical framework that decreased and then increased in size rapidly, with fins formed of equal length from the inlet of the conical framework to the point of minimum radius, as shown in FIG. 13. This configuration enabled the utilization of two velocity systems, venturi and outer wind flow/eddy creation, for increasing velocity and decreasing pressure within the conical framework. The eddy creation system (the fins) created a vacuum, as shown in FIG. 14, that also increased velocity, as shown in FIG. 15. In the test, the two velocity systems increased the estimated wind power through the system by 144%.

Projections include, for an embodiment having a 15 hp motor and using a 60 inch diameter turbine, the ability to generate more power than the motor powering the exhaust fan. Such an embodiment may produce 6.45 kWh from the generator, and the exhaust fan motor would be consuming 11.19 kWh, yielding a 57.6% efficiency in electricity generation compared to consumption. This is possible due to the high energy conversion rate of the Newtonian Turbine and the benefits to wind velocity from the conical framework disclosed herein. Testing of embodiments of the present disclosure has shown the benefits of the conical framework, including realizing significantly more velocity, which is cubic in the power generation formula, Power=(Density*Swept Area*Velocity\hat{ }3)/2. Since power scales to conversion directly, it can be shown that a 40%-50% conversion may result from a 144% power increase beyond only using a Newtonian turbine. This 144% increase is attributed to the inclusion of the conical framework.

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

I claim:

1. A system for generating electric power from an exhaust wind expelled by an exhaust system having an exhaust outlet, comprising:
a conical framework disposed substantially downstream of the exhaust outlet;
a Newtonian turbine disposed substantially downstream of the exhaust outlet, wherein the Newtonian turbine is positioned a first distance from the exhaust outlet, wherein the Newtonian turbine is substantially concentric with the conical framework, wherein the Newtonian turbine includes:
a rotor having an outer rotor surface and a rotor diameter, wherein the rotor is operatively connected to a low-speed driveshaft;
a hub substantially concentric with the rotor, the hub having an inner hub surface and a hub diameter; and
a turbine blade having a first blade end and a second blade end, the first blade end connected to the outer rotor surface and the second blade end connected to the inner hub surface; and
an electric generator including a high-speed driveshaft, wherein the high-speed driveshaft is operatively connected to the low-speed driveshaft, and wherein the electric generator configured to generate electric power when the high-speed driveshaft is turned.

2. The system of claim 1, wherein the first distance is determined to maximize a wind velocity through the turbine, to minimize an accumulation of heat or air between the exhaust outlet and the Newtonian turbine, or based on an exhaust outlet diameter of the exhaust outlet.

3. The system of claim 1, wherein the hub diameter is smaller than or substantially equal to an exhaust outlet diameter of the exhaust outlet.

4. The system of claim 1, wherein the Newtonian turbine is connected to the conical framework via a bearing.

5. The system of claim 1, further comprising support legs connected to the conical framework.

6. The system of claim 1, wherein the conical framework is connected to the exhaust outlet.

7. The system of claim 1, wherein the conical framework includes a duct disposed such that a portion of the exhaust wind passes through the duct before impinging on the Newtonian turbine; and wherein the duct is converging, diverging, or straight.

8. The system of claim 1, wherein a conical framework inlet diameter of a conical framework inlet of the conical framework is smaller than an exhaust outlet diameter of the exhaust outlet.

9. The system of claim 1, wherein the Newtonian turbine, the low-speed driveshaft, and the electric generator are disposed within the conical framework.

10. The system of claim 1, wherein the low-speed driveshaft is supported by a bearing and a mount, and wherein the high-speed driveshaft is operatively connected to the low-speed driveshaft via a gearbox.

11. The system of claim 1, wherein the hub is tapered such that it is substantially frustoconical in shape, the hub having an inlet diameter of an inlet smaller than an outlet diameter of an outlet.

12. The system of claim 1, wherein the conical framework is tapered such that it is substantially frustoconical in shape, the conical framework having an inlet diameter of an inlet smaller than an outlet diameter of an outlet.

13. The system of claim 1, further comprising a regulation system configured to regulate a taper of the conical framework.

14. The system of claim 13, wherein the regulation system is a hydraulic system.

15. The system of claim 13, wherein the regulation system is controlled by a controller based on a wind speed input and a maximum operating torque of the electric generator, wherein the wind speed input includes a wind speed measured by an anemometer.

16. The system of claim 1, wherein the conical framework is connected to the exhaust system using a ring brace.

17. The system of claim 1, wherein the electric generator is an asynchronous generator, a doubly-fed induction generator, a permanent magnet system generator, or a squirrel cage induction generator.

18. The system of claim 1, further comprising an extrusion on the fan blade.

19. The system of claim 18, wherein the extrusion has a cross section of a right triangle having a straight hypotenuse or a curved hypotenuse.

20. A method for generating electric power from an exhaust wind expelled by an exhaust system having an exhaust outlet, comprising:
passing the exhaust wind into a conical framework;
impinging the exhaust wind on a Newtonian turbine operatively connected to a low-speed driveshaft after passing the exhaust wind through the conical framework, wherein the Newtonian turbine is positioned a first distance from the exhaust outlet, wherein the Newtonian turbine includes:
a rotor having an outer rotor surface and a rotor diameter, wherein the rotor is operatively connected to a low-speed driveshaft;
a hub substantially concentric with the rotor, the hub having an inner hub surface and a hub diameter; and
a turbine blade having a first blade end and a second blade end, the first blade end connected to the outer rotor surface and the second blade end connected to the inner hub surface; and
generating electric power using an electric generator including a high-speed driveshaft, wherein the high-speed driveshaft is operatively connected to the low-speed driveshaft, and wherein the electric generator configured to generate electric power when the high-speed driveshaft is turned.
